(19) United States
(12) Patent Application Publication
(10) Pub. No.: US 2005/0134462 A1
(43) Pub. Date: Jun. 23, 2005

(54) RFID and photovoltaics

(76) Inventor: Michael Gerard Shelley, Libertyville, IL (US)

Correspondence Address: Michael G. Shelley, 1203 Sussex Lane, Libertyville, IL, 60048, US

(21) Appl. No.: 11/004,715

(22) Filed: Dec. 6, 2004

Related U.S. Application Data
(60) Provisional application No. 60/528,062, filed on Dec. 10, 2003.

(51) Int. Cl. G08B 13/14

(52) U.S. Cl. 340/572.8; 340/693.1

(57) ABSTRACT

An invention for that incorporates RFID technology and a chip (2) with photovoltaic cells (1). To eliminate in some cases the need for batteries in active RFID tags or transponders. An invention that also uses rechargeable batteries (6) and also incorporates them connecting the batteries (6) to the photovoltaic cell (4) to recharge battery (6). This invention also covers all aspects related to combining or merging these two technologies RFID (Radio Frequency Identification) and Photovoltaics.

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF THE INVENTION FIELD OF THE INVENTION

This invention relates to the merging of Radio Frequency Identification and Photovoltaics.

### BACKGROUND OF THE INVENTION

Radio Frequency Identification relies on a computer chip to hold information loaded onto it for later retrieval with a device called a reader. These computer chips have an aerial attached. These computer chips are called transponders, or tags. They come in two types. Passive or active. A passive tag is one where there is not battery required to hold the information. An active tag does require a battery to hold the information.

Active RFID transponder, or tags are very expensive. The batteries have to be changed. In most cases the information is lost due to the battery dying. This is usually not known until someone tries to retrieve the information that now is no longer there.

This invention is also meant to include the merging of photovoltaic technology and RFID equipment such as the readers and scanner used to read the transponder tags. Currently it takes batteries or a hard wired setup for the readers/scanners to be used. There are times where remote locations will preclude having a hard wire application and batteries are not practical. A reader/scanner that has photovoltaics incorporated into the equipments design would be more practical.

This invention is not intended to eliminate the batteries used with active tags, but not in all circumstances. This invention is meant to cover both inclusive and exclusive need for batteries with active tags. This invention is also meant to cover all associated equipment and accessories that currently need batteries to run and all parts of a complete RFID system. There are scenarios that do require batteries.

A search done by the inventor and to the best of his ability has turned up no prior artwork or existing patents related to this patent application. The inventor can not reference any prior art to discuss design flaws for validity of this invention. This invention does have a market in the RFID industry especially from a cost savings standpoint.

### BACKGROUND OF THE INVENTION—OBJECTS AND ADVANTAGES

The batteries used in active transponders are usually hearing aid or watch type batteries. The cost for these types of batteries is in the range of $3.00 to $8.00 US dollars depending on the manufacturer. Lifespan of these batteries vary depending on their use and power consumption of the appliance being used. The use of batteries has made the saleable cost of active transponders to be as high as $30.00 US dollars per transponder. This cost in most cases does not include a battery due to issues of battery shelf life. This invention should significantly bring down the cost of an active transponder or tag.

### SUMMARY

This invention is to join two technologies to help bring down cost. This invention is not meant to eliminate the batteries use for some circumstances. This patent is mean to be inclusive and exclusive of a battery and its need related to active transponders for RFID technology. This invention is also to include all the equipment used transponders, readers, scanners and all other accessories to incorporate photovoltaics with every piece of RFID equipment that comprises a complete RFID system.

### DRAWINGS—FIGURES

FIG. 1. Shows a round photovoltaic cell with an RFID transponder chip attached to the photovoltaic cell.

FIG. 2. Shows a round photovoltaic cell with an RFID transponder chip attached to the photovoltaic cell and includes a battery.

FIG. 3. Shows a reader writer scanner with a photovoltaic cell incorporated in the equipment.

FIG. 4. Shows a ceiling or wall mounted reader scanner with photovoltaics.

FIG. 5. Shows a wiring schematic for invention.

### DRAWINGS—REFERENCE NUMERALS

1 photovotlaic cell
1A aerial
1B connective aerial wires
2 rfid chip
3 photovoltaic wires
4 photovoltaic cell
4A aerial
4B aerial connective wires
5 rfid chip
6 rechargeable battery
7 wires from photovoltaic cell to rfid chip
8 wires from rechargeable battery to rfid chip
9 handheld read writer body encasement
10 photovoltaic cell window
11 led output read window or screen
11A internal battery
12 trigger button to scan a chip
13 usb port for cable connection
14 wall mounted scanner body
15 photovoltaic cell window
16 scanner eye for scanning a room
17 photovoltaic cell
18 rfid chip
19 rechargeable battery
20 wires from photo cell to rfid chip
21 wires from battery to rfid chip
22 wires from photo cell to charge rechargeable battery
23 aerial for rfid chip
24 connecting wires from aerial to rfid chip

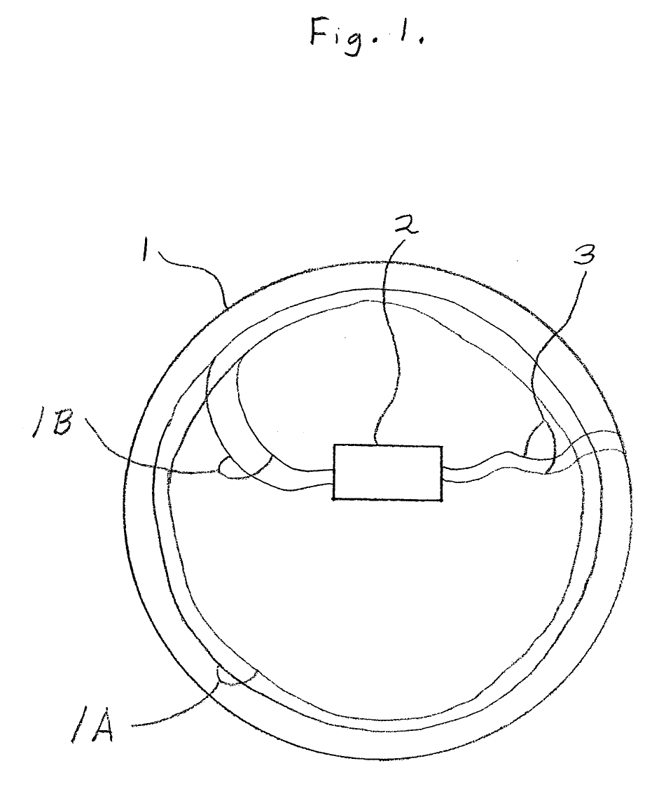

### DETAILED DESCRIPTION OF FIGS. 1 THRU 5

FIG. 1 shows the invention exclusive of a battery. The outer circle 1 is the photovoltaic cell. On the cell 2 is the RFID chip which shows electrical connection wires 3 leading to the photovoltaic cell. Attached to the RFID chip also is an aerial 1A and the connection wires 1B that go back to the RFID chip.

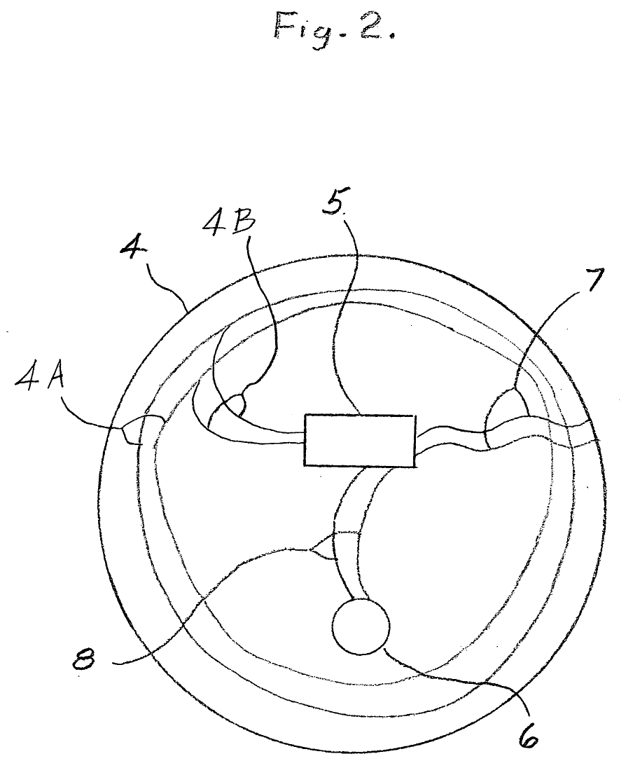

FIG. 2 shows the invention again but with a rechargeable battery 6 included in the invention. The other components as in FIG. 1 stay the same. The outer circle 4 is the photovoltaic cell. The aerial 4A and connecting wires 4B go to the RFID chip 5. The wires 7 are for the photovoltaic cell and is the connection to the RFID chip. The battery wires 8 are shown coming off the battery 6 going to the RFID chip 5.

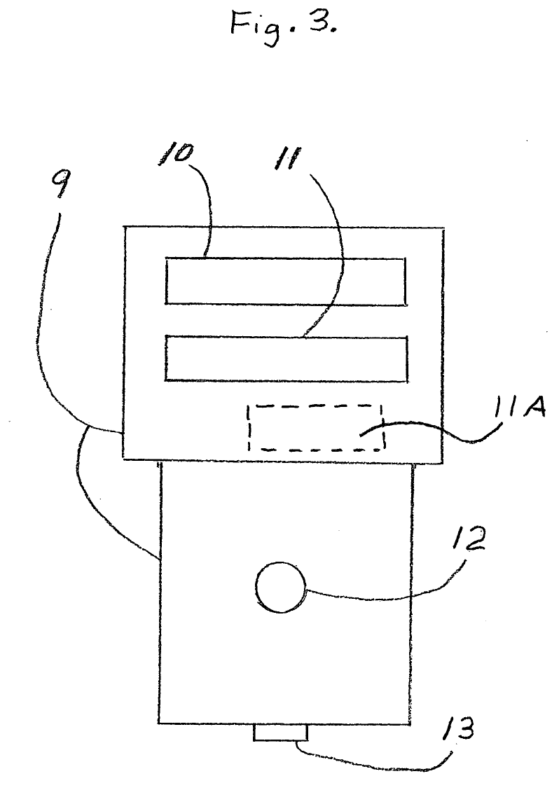

FIG. 3 shows a hand held read and writer scanner that can write code to RFID chips and also scan and read the information back to the hand held unit. The body 9 made from plastic or metal holds all the internal wiring and circuit boards hidden inside and not shown. The hand held unit has a photovoltaic window 10 that powers the unit. The hand held has an LED display window 11 to show information that is scanned back to the operator. The hand held scanner does have an internal battery pack that can be either a rechargeable type or not. The unit has a single trigger button 12 to activate and scan a chip with a single push of the button 12. This read writer hand held scanner does need a computer to allow for loading of information into the RFID chips.

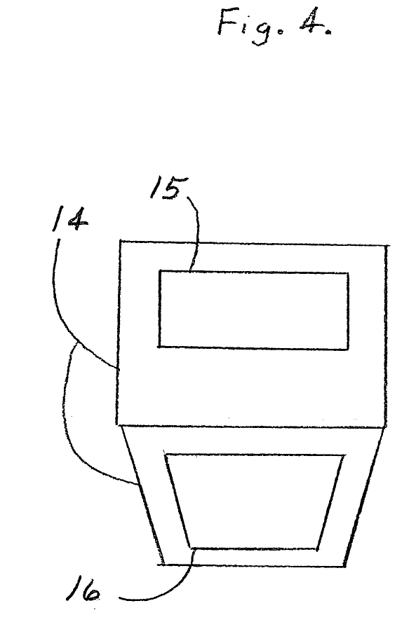

This figure shows 13 as a USB cable port to computer interfacing. FIG. 4 shows a wall mount scanner with the body being 14. The scanner uses a photovoltaic cell 15. The scanner has a reader aerial window 16. Internally for FIG. 4 not shows is wiring that allows for hard wiring to a standard 110 or 120 volt electrical system.

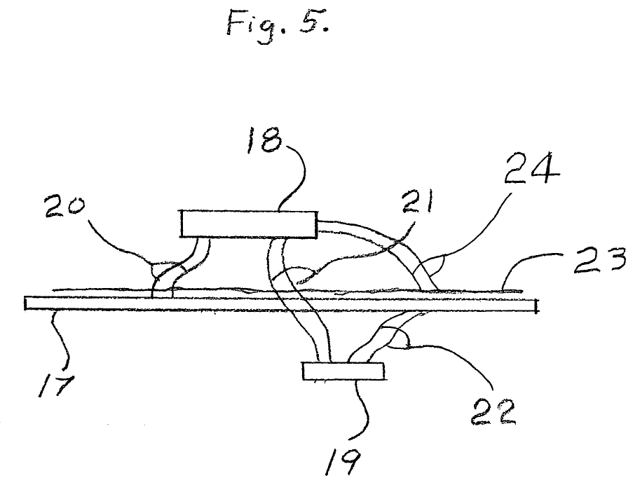

FIG. 5 shows a side view of FIG. 2 with all of the same components shown and discussed above in FIGURE FIG. 2.

1. This invention is meant to reduce the cost of an active battery operated RFID chip with the use of photovoltaics.

2. This invention thou is not meant to completely eliminate the battery.

3. This invention is meant to increase the life of the rechargeable batteries described above and increase read ranges for the RFID chips.

4. This invention does not eliminate in FIG. 1 the batteries necessity entirely but yet there are circumstances that require that the battery remain a function of this invention.

5. This invention does not show in FIGS. 1 and 2 what possible encasement or enclosures might look like. This patent should be inclusive of any enclosure for the invention. Enclosures are at the manufacturers discretion after licensing or the patents outright purchase.

6. This invention does show in a rough way wiring schematics. Like the above claim number 2 the final wiring schematic will be up to the manufacturer. This patent should be inclusive of any or all possible wiring schematics.
